(19) United States
(12) Patent Application Publication
(10) Pub. No.: US 2014/0317228 A1
(43) Pub. Date: Oct. 23, 2014

(54) Integrate Application Intelligence with a Network Device for Application Transaction Visibility and Control

(71) Applicant: CISCO TECHNOLOGY, INC., San Jose, CA (US)

(72) Inventor: Srinivas Dharmasanam, San Jose, CA (US)

(73) Assignee: Cisco Technology, Inc., San Jose, CA (US)

(21) Appl. No.: 13/866,523

(22) Filed: Apr. 19, 2013

(51) Int. Cl. H04L 12/26

(52) U.S. Cl. CPC H04L 43/00
USPC 709/217

(57) ABSTRACT

The proposed methodology provides an application state machine in a network device, such as a router which may be used to extract application transactions. The extracted transaction data may be provided to another entity for analysis and troubleshooting.

### BACKGROUND

Due to the absence of adequate application level state information in a network device (such as a deep-packet-inspection device), it may be extremely difficult to achieve application transaction visibility (and impossible to effect control). For example, application specific transactions, such as the opening, closing, saving, and/or reading of a document, may not be acceptably visible from traditional network monitoring devices.

Resultantly, application performance management (for example, troubleshooting and capacity planning) may require coordination from network operations teams as well as application server management teams. Such coordination may be difficult to achieve due to a network having servers with data centers that are managed and administered over a plurality of networks located in geographically remote locations. Furthermore, it is common that application management teams may not be well schooled on networking and vice versa.

### BRIEF DESCRIPTION OF THE DRAWINGS

The accompanying drawings, which are incorporated in and constitute a part of this disclosure, illustrate various embodiments. In the drawings:

FIG. 1 illustrates an example network environment for embodiments of this disclosure;

FIG. 2 is a flow chart illustrating embodiments of this disclosure;

FIG. 3 is a flow chart illustrating embodiments of this disclosure;

FIG. 4 illustrates an example network environment for embodiments of this disclosure;

FIG. 5 is a block diagram of a computing network device.

### DESCRIPTION OF EXAMPLE EMBODIMENTS

### Overview

Consistent with embodiments of the present disclosure, systems and methods are disclosed for providing application transaction visibility.

In some embodiments, a method for improving application level intelligence is described comprising: establishing an application state machine at a first network device; constructing a first application data packet; generating transaction data from the first application data packet relating to a first application at the application state machine; and transmitting the transaction data related to a first application to a remote entity.

In some embodiments, a method for improving application level intelligence is described comprising: constructing a first application packet associated with a first application; determining a first application transaction based on transaction information gleaned by the first application packet; and maintaining a session state for the first application in a first application stack.

It is to be understood that both the foregoing general description and the following detailed description are examples and explanatory only, and should not be considered to restrict the application's scope, as described and claimed. Further, features and/or variations may be provided in addition to those set forth herein. For example, embodiments of the present disclosure may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of this disclosure may be described, modifications, adaptations, and other implementations are possible. For example, substitutions, additions, or modifications may be made to the elements illustrated in the drawings, and substituting, reordering, or adding stages to the disclosed methods may modify the methods described herein. Accordingly, the following detailed description does not limit the disclosure. Instead, the proper scope of the disclosure is defined by the appended claims.

Past efforts to attempt to provide application transaction visibility include the deployment of software plug-ins at server and/or client devices to monitor transactions. However, with server and client sprawl, it becomes a very onerous task to isolate and resolve problems at either the client or server devices along with the cost and complexity of installing the plug-ins at the client and/or server devices.

Other past efforts include the installation of a deep-packet-inspection (“DPI”) which may be capable of looking deeper into various packet headers. The DPI may be able to parse the specific protocol and limited related operations. These approaches merely provide limited application awareness. Much more detailed awareness may be required to identify various application level performance metrics. For example, past approaches are unable to determine the time it takes to open a word processing document.

Embodiments of the present disclosure may be employed for any number of file protocols. For examples used herein, the disclosure focuses on the Server Message Block Protocol (“SMB”) application to illustrate embodiments of the present invention. SMB may also be known as Common Internet File System (“CIFS) and may operate as an application layer network protocol used for providing shared access to data and communications between nodes on a network. It should be understood that embodiments of the present disclosure are equally applicable for other file protocols whether or not described in detail herein.

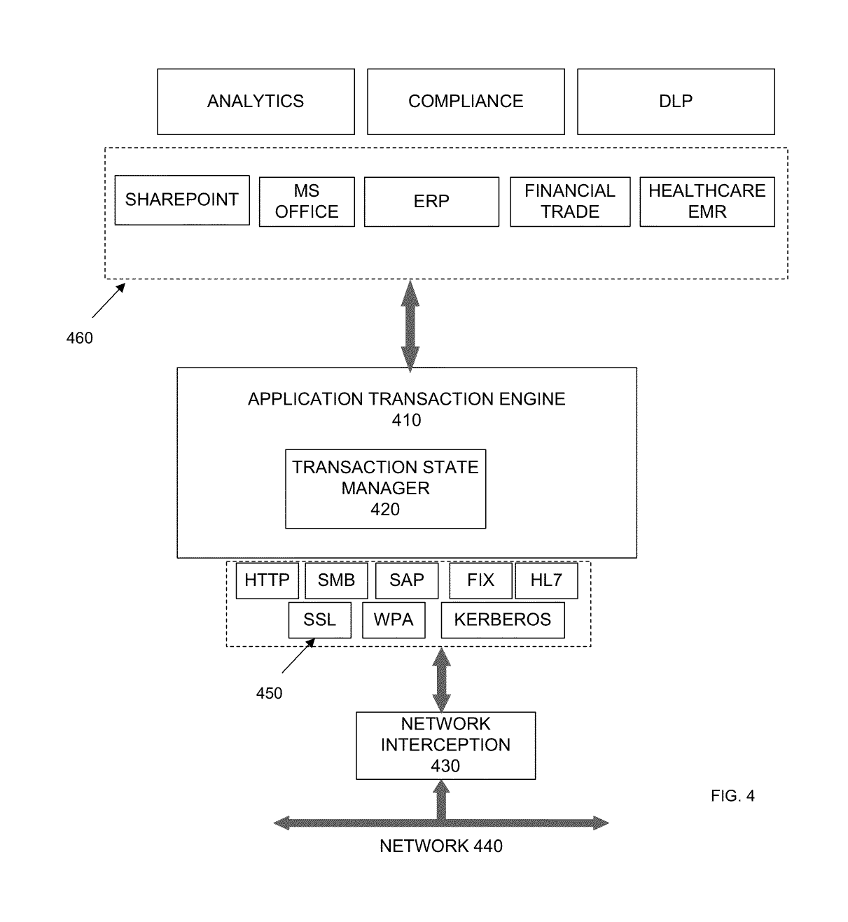

SMB may include a protocol parser. The protocol parser may be used to construct a complete SMB packet. The SMB packet can be created either in an active mode or a passive mode. While in a passive mode, the TCP flow is watched between client and server end-points as the data segments travel by in both directions. These TCP endpoints may not know about this listen-mode entity. Such an approach may be used for various networks sessions whether encrypted or non-encrypted, and whether the session is signed or unsigned. The differences between encrypted and non-encrypted embodiments are illustrated in further detail below with respect to FIG. 4.

In an active mode, the TCP connection may be terminated at the network device. In some embodiments of the present disclosure, the network device at which termination takes place may be a server providing WAN Optimization Service (Eg. WAAS). The TCP connection may be subsequently reinstated at the network device towards the server. In active mode, the network device may have the ability to act in-band (for example, to provide optimization).

If the functionality is to only work as a monitoring device, then it may sufficient to be in the passive mode and thus not be necessary to terminate the TCP connection, thus potentially saving additional resources.

Once a SMB packet is constructed (for a request or a response), the application stack may maintain a minimal session state which generates the particular transaction records of interest. Transaction records of interest may include, but are not limited to the opening, closing, and saving of various types of application files. These transactions may then be provided to another entity by using a standardized protocol. One such appropriate protocol may be Netflow.

NetFlow is a flexible method to record network performance data. Netflow may provide a key set of services for IP applications, including network traffic accounting, usage-based network billing, network planning, security, Denial of Service monitoring capabilities, and network monitoring. NetFlow provides valuable information about network users and applications, peak usage times, and traffic routing.

A typical analytics workflow may start with unstructured data (log files, different types of files and formats, images, etc.) ingested from a source and then processed to generate structured data (into a database schema) that is summarized and then aggregated in order to derive higher-level meaningful information. This information can then be used by the particular business to drive business decisions such as workflow improvement, data-driven decision making, etc. to drive additional targeted advertising, etc.

With increasing volumes and types of unstructured data (files of different formats, various types of server logs, images, videos of different formats, etc.) the problem of deriving meaningful information of business value in a timely manner is getting increasingly complex and time consuming. Embodiments of the present disclosure address this problem by feeding the analytics workflow with structured data containing application transaction information (either directly from a device that is generating the data or from a datastore) so that the processing overhead and the data storage requirements are significantly reduced and at the same time providing a simpler and more powerful realtime platform for analytics.

For example, in the case of Sharepoint, an “upload” transaction is one such example. Without such application transaction awareness in the network device, a system would need several the http GET and POST request and response headers (variable sized fields) to be captured (across different TCP connections) and streamed up to the analytics engine that has to construct state from these individual http requests and responses (up to 10's or even higher depending on the particular file size, etc.) This approach cannot scale to many 1000's of connections due to the volume of the workload and the requirements to be complete the analytics processing in realtime.

The protocol parser for SMB may be used to construct a complete SMB packet (including encryption/decryption) which is a request or a response. The application transaction (a file open, directory browse, etc.) may then be determined by the type and chronological order of a specific set of the protocol requests. The application transaction may be identified by a single such protocol request or from multiple requests tied together in a well-defined manner. For example a word processing document open operation may involve several SMB protocol file open commands, read commands, etc. Each of these commands may be tracked in the application transaction aware module. At the end of such a transaction, it can then export (via Netflow, protocol buffers, etc.) a transaction record according to the interface that is a “structured” format to be ingested in to the analytics pipeline. The analytics engine may be running internal/external to the device that is generating these transactions depending on the resource constraints of the device.

Since these transaction records are structured, the realtime analytics platform can run predefined queries (Ex. SQL queries) on a rolling window (for example, every one minute) on such buffered transaction records. The overhead of processing such a data stream can be minimal where initial “near-edge” analytics on in-memory data sets can be applied for immediate feedback-control (if required). This initial level of summarized data is persisted in long-term data stores for additional analytics with more complex algorithms and historical data aggregation thus providing a scalable architecture for realtime data analytics.

By building application transaction awareness in a network device (such as a router, WIFI access point, WAN optimization appliance, etc.); extracting application transactions from the flow in a structured form; and streaming it to a real-time analytics engine, the amount of such data that is streamed may be greatly reduced (thus saving the network bandwidth). Furthermore processing overhead on the streams may also be reduced, thus reducing the cost, turnaround time, and complexity of the processing and storage. As such, embodiments of the present disclosure may provide simpler, more efficient and also more powerful (ex. realtime feedback and control in the data path) analytics solution.

Prior art systems have not provided a common object model for application transactions across different application domains (financial sector, health care, application performance management, etc.). In the performance management domain, the one commonly used object model (Netflow) suffers from not being extensible. In other words, Netflow lacks the ability to capture a user-defined application transaction without requiring any modifications in the underlying platform.

The consumers of analytics information tend to be implemented in silos with each one tailored for the particular domain. In the absence of such a common, consistent, and extensible model, the problem of programming various network devices to generate analytical information and export it becomes very difficult. For the same reason, the entity that digests and/or provides a user-friendly interface may also face difficulty (since there are multiple sources each with different associated object models).

Embodiments of the present disclosure address this problem by developing a common interface model that is layered with the following levels: flow level, session level, and application transaction level. The flow level interface model covers how multiple modules are attached to a module for particular flows of interest. The flows may be specified with a 5-tuple. (ex. 5-tuple of source IP address, destination IP address, ports, TOP information, and UDP information). This can be dynamic where the flow tuples of interest may be learned. For example, in an e-mail application, the port mapper application may provide the specific tuples of interest and the tuples may be dynamically inserted into the network.

The disclosed session level interface model provides a mechanism to be able to attach the described module to specific sessions. A session may be defined in a common way across different applications. Common attributes may include: user name, type of session, file services share, etc.

The application transaction level interface model provides the interface for application protocols to capture the transactions of interest, such as the opening of a word processing document over the SMB protocol. The application transaction level interface model further provides how to build an interface for it. For extensibility, the interface may provide a model to tie various protocol level constructs (open, read, save, etc.) as a set of objects that form one application transaction.

Embodiments of the present disclosure integrate application intelligence with a network device. Embodiments operate to identify and export application transaction information to provide real-time application level feedback control. The interface provided may be extensible and application protocol agnostic. The interface provides for tracking and exporting business transactions.

As a result, when new application and/or new business transactions occur, there is no need to engineer or redesign the underlying software as the framework provides an extensible interface. A user may plug-in a new application protocol parser with a well-defined interface within a software stack. The protocol parser may be used to define any business transaction using a common application transaction grammar.

Embodiments of the present disclosure may be used for application performance management and business analytics. Embodiments may be employed in existing customer environments with a typical enterprise application management domain. Such environments may include, but is not limited to, SMB with Microsoft Office applications, HTTP with Microsoft Sharepoint applications, and Citrix Independent Computing Architecture (“ICA”) for use with virtual desktop devices.

Furthermore, appropriate environments may be industry-based environments, such as the Financial Information eXchange (“FIX”) protocol used for financial transactions. FIX is a series of messaging specifications for the electronic communication of trade-related messages. FIX is a specification around which software developers can create commercial or open-source software, as they see fit.

Another industry environment with an extensible protocol for embodiments of the present disclosure is the healthcare industries. Healthcare transactions may be performed in using a Digital Imaging and Communication in Medicine (“DICOM”) or a Health Level 7 (“HL7”) protocol.

DICOM was developed for handling imaging data. This cooperative standard assists communication between various image based modalities and accessories to each other. Broadly, it focuses on workflow of images. It provides reliable protocols for integration of image data between imaging, nonimaging modalities, devices and systems.

In particular, a DICOM Service Class is defined as a group of operations that a user wants to perform on data from a modality. Typical examples of Service Classes include Print Management Service Class that deals with printing images on film or paper printer, with flexible film formats, Storage Service Class that implies “sending” images and Query/Retrieve Service Class that deals with issues of “find, move and get” SOP (Service Object Pair) Classes. While “find” is used to query for images, “move” and “get” are used to commence a transfer. Each of these application transactions may be monitored by embodiments of the present disclosure.

Similarly, HL7 may provide for the management of non-imaging data with protocols for the exchange, management and integration of clinical and administrative electronic health data. HL7 is the accepted global standard for exchange, integration, sharing and retrieval of electronic health information in hospitals. The seventh or highest “level” of HL7 is regarded as the application level, which deals with the definition of data to be exchanged. This level supports varied functions, such as security checks, participant identification, availability checks, exchange mechanism negotiations and data exchange structuring.

In any of the above-described environments, the architecture described in embodiments of the present disclosure, provide the ability to view network level metrics. (i.e., from the flow level, http, TOP UDP, etc. . . . ) Furthermore, application level metrics may be viewed (i.e., application transaction latencies, throughput, etc. . . . ) This level of visibility is provided without a need to install client-server plug-ins to access the application information.

As described embodiments may provide a combined view of network and application level metrics, it becomes much easier to isolate and troubleshoot problems at both the network and application levels. Created transaction records may be more robust and useful as they capture very granular information closest to the edge. This reduces the overhead of transmitting the data over the wire for offline processing. Such an approach mitigates the data deluge problem.

Presently described embodiments, provide a powerful application aware engine at the source. The application aware engine may be able to affect real-time feedback control in the application path. For example, application packets may be injected for specific messages to be seen by the user. Such specific messages may include, but are not limited to, targeted advertisements, targeted coupons, and specific error and/or diagnostic messages through a browser.

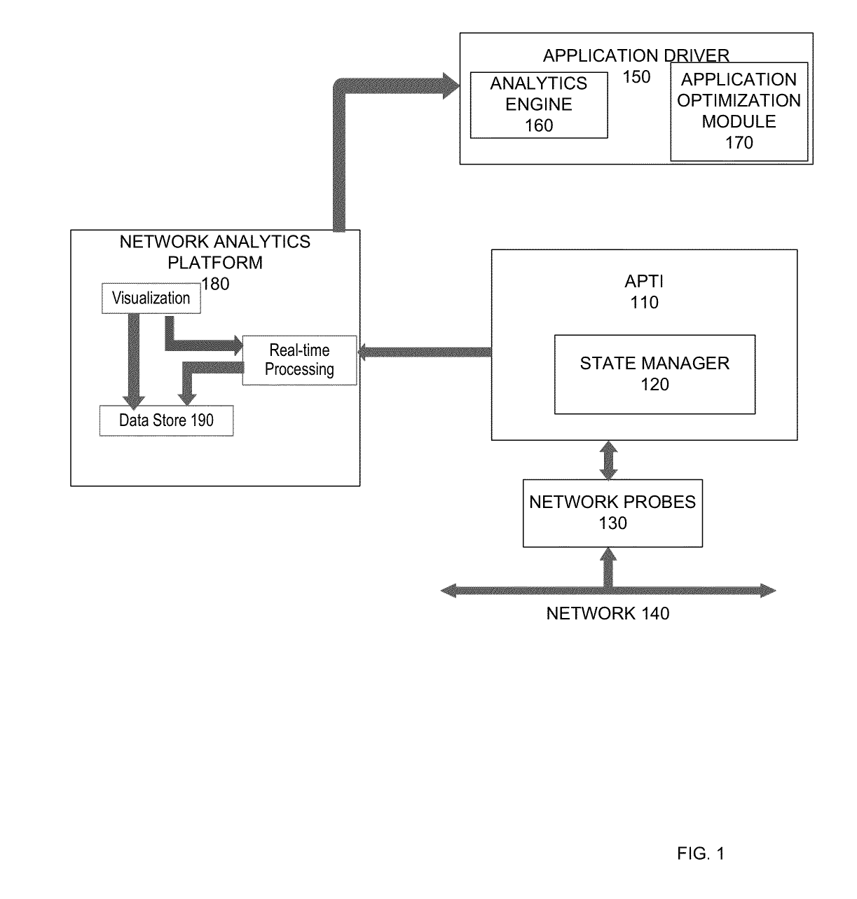

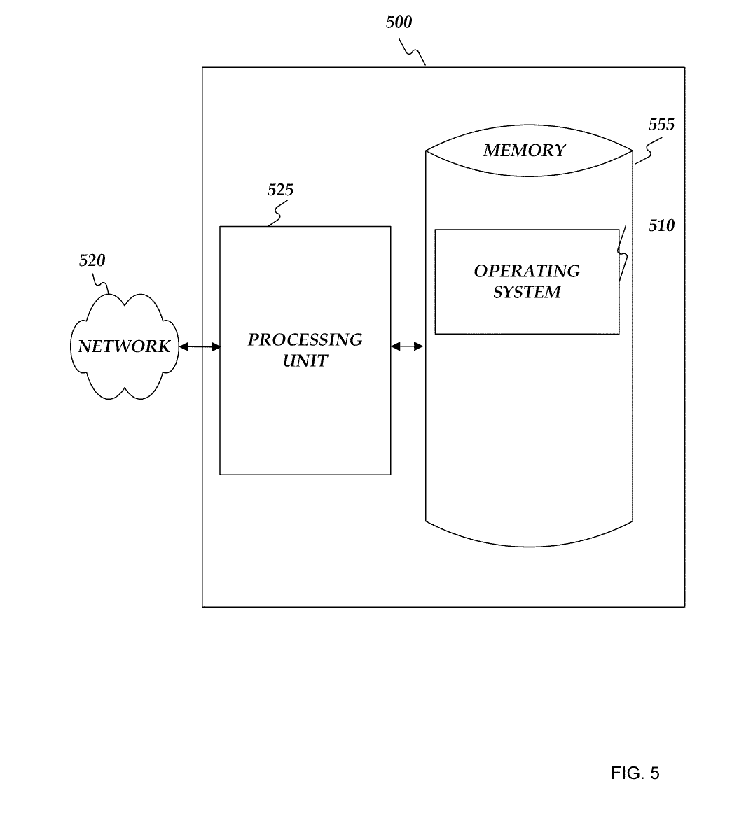

Referring to FIG. 1, an example of an operating environment for embodiments of the present disclosure is shown. A network device 100 in which embodiments described herein may be implemented is shown. The embodiments described herein may operate in the context of a data communication network including multiple network devices. Some of the devices in the network may be routing bridges, switches, bridges, routers, gateways, or other network devices. In some embodiments, the network device is implemented on a general purpose machine as described below with respect to FIG. 5.

In some embodiments, network device 100 may provide an Application Transaction Aware Interface (“APTI”) 110. APTI 110 may be part of a module layered within network device 100. APTI 110 may provide a simple and powerful platform to maintain application state information with a state manager 120.

APTI 110 may provide network probes 130 capable of gathering and gleaning information about network activity, and more specifically about application transactions. Network probes 130 may provide a way to access the data flowing across a network such as network 140. In many cases, a network probe may have three ports: an A port, a B port, and a monitor port. A tap inserted between A and B passes all traffic through unimpeded, but also copies that same data to its monitor port, enabling a third party to listen.

Network probes 130 may also include a network-integrated WAN optimization solution available with virtualization technology to reduce operational complexity in enterprise wide WAN optimization deployments. WAN optimization resources may be virtualized in the data center by pooling them into one elastic resource in a manner that is policy based and on demand with the best available scalability and performance.

Application driver 150 may be in communication with APTI 110. Application driver 150 may provide an analytics engine 160. Analytics engine 160 may be capable of the real-time processing of events tracked by APTI 110. Application driver 150 may further provide optimization modules 170 for a plurality of compatible applications. Analytics engine 160 may provide real-time feedback at the application level back to a specific data flow.

Application transaction records may be streamed a network analytics platform 180 for real-time processing and visualization for a user. In some embodiments, network analytics platform 180 may be remote from network device 100. Network analytics platform 180 may include a data store 190. Data store 190 may be used to store application transaction data. Data stored in data store 190 may be analyzed at periodic intervals and/or through the use of rolling windows that cover a predetermined period of time.

In an example case, a user may contact IT support to report “slowness” in the network. It may not be clear whether the problem is a network issue or an application issue. A web-based interface may be provided as part of network analytics platform. The interface may illustrate current activity for the user.

Example activity for the user in this example may be that the user has twenty files open. For each open file, application data will be learned for time of access, server information, file sharing information, time to open the document, time to save the document, etc. From this information it may be learned that the user is getting 100 IO operations per second with 10 Mps goodput to “server1:\share1\”.

Embodiments of the present disclosure may recognize two errors in the application protocol in this example. For each of these errors, a string may be displayed to describe the error. For example, “Access Permission denied for document1”.

It may also be determined from the application data that the user has sent and/or received ten e-mails over the past five minutes. For each e-mail, application data may be learned including server information, delivery time, sender and recipient address information. From this information it may be learned that the user is getting 100 IO operations per second with 2 Mbps goodput to “exchangeserver1”.

The learned application data concerning the user may be provided to APTI 110. APTI 110 may provide a predefined set of enterprise transactions. Such enterprise transactions may include “business critical” transactions served as reference to add additional user-defined transactions using the APTI 110 module to provide a dashboard to display per-user, per-application feedback via network analytics platform 180.

In a second example, two users may be connected to a data center via a virtual desktop (VDI stream). Under normal conditions, the two users may be accustomed to having a good user experience. However, under bursty or peak usage from a first user, the second user may suffer from degraded performance due to congestion in the network. Here, embodiments of the present disclosure may first detect the congestion in the network. Quality of Service metrics may be applied to one or more VDI streams. For example, a Differentiated Services Code Point (“DSCP”) setting may be adjusted to set the second user to a higher drop rate. This way only the second user experiences degraded quality, while the first user retains a good experience.

In a further example, a plurality of users in the financial sector may be using software to conduct financial transactions. The FIX messaging specifications for the electronic communication of trade-related messages may be used with embodiments of the present disclosure to identify transaction types and problems related thereto. This adds a layer of business intelligence to the baseline information of the financial transactions themselves. Such information may be used to streamline the system.

The application awareness provided by embodiments of the present disclosure may handle streams whether they are encrypted or compressed. Embodiments further provide dynamic determination of virtual channels and TCP connections used for application transactions. Thus, there may be no need for a network administrator to have a server, such as an Independent Computing Architecture (“ICA”) server configured to use specific destination ports regardless of additional session reliability support. The provided generic and extensible application transaction interface module supports SMB, HTTP, FIX, and many other protocols. The architectural model can then be leveraged in any number of industry-based systems.

Here, analytics engine 160 may show network congestion is a result of excess usage by the second user. In that case, reduced priority DSCP markings are set for virtual channels used for specific ongoing connections. This may free up network bandwidth for other users. These user directives may be provided by the analytics engine 160 to APTI 110 for effecting the control changes.

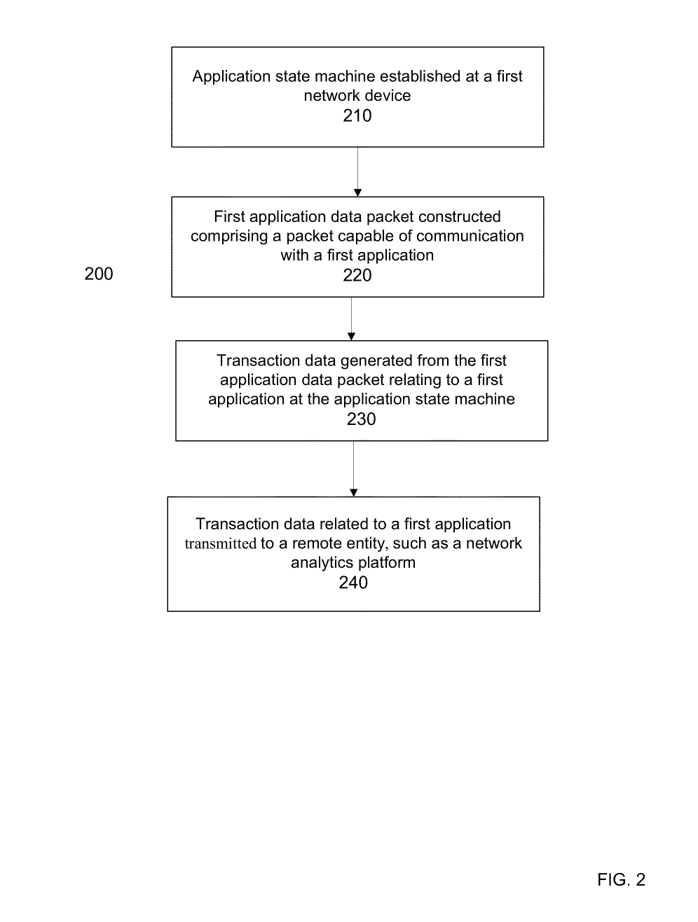

FIG. 2 is a flow chart illustrating embodiments of the present disclosure. Method 200 may begin at step 210, where an application state machine may be established at a first network device. As discussed above, the state machine may be part of APTI 110. In some embodiments, the application state machine may be maintained in an application stack at the first network device

Method 200 may proceed to step 220, where a first application data packet may be constructed comprising a packet capable of communication with a first application. In some embodiments of the present disclosure, the application data packet may be an SMB packet. In some embodiments, the first application data packet may comprise a source IP address, a destination IP address, and information associated with a network flow to contact ports

The first application data packet may be generated by a protocol parser stored in the application stack. The first application data packet may be further constructed according to the rules of an object model providing a common interface for monitoring application transactions over a plurality of application domains.

Next, at step 230 transaction data may be generated from the first application data packet relating to a first application at the application state machine. In some embodiments, the first network device may operate in a listen mode and extracts application-specific data from TCP data transmitted through the first network device. In other embodiments, the first network device may be operated in an active mode and extracts application-specific data from a data flow terminated at the first network device. The data flow may be in-band optimized on the extracted application-specific data.

Finally, at step 240, the transaction data related to a first application may be transmitted to a remote entity, such as a network analytics platform. In some embodiments, the transaction data comprises data related to at least one of: opening a document, closing a document, and saving a document.

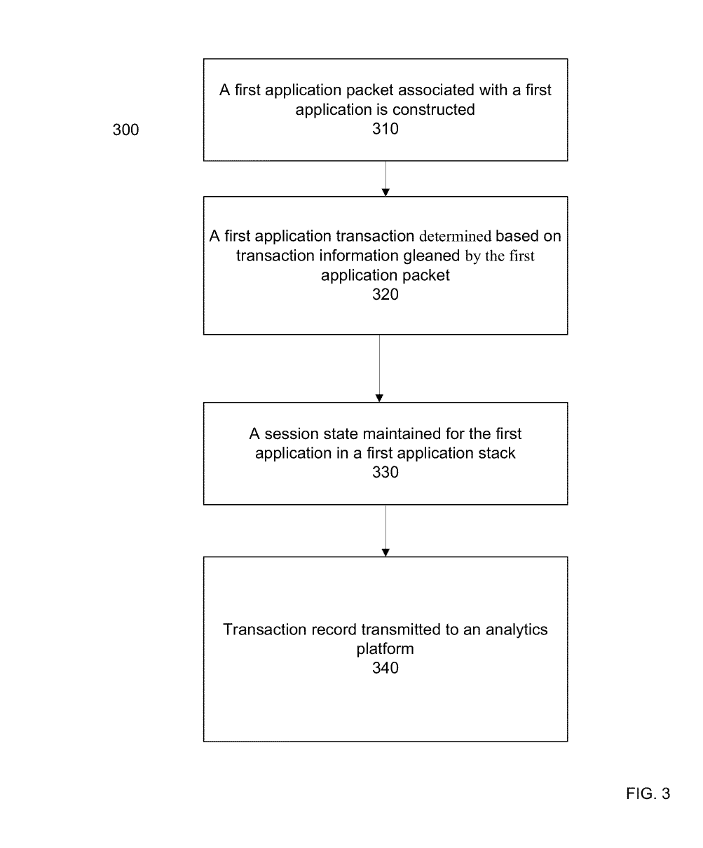

FIG. 3 is a flow chart illustrating embodiments of the present disclosure. Method 300 may begin at step 310 where a first application packet associated with a first application may be constructed. The packet may be constructed by a protocol parser.

Method 300 may then proceed to step 320. At step 320, a first application transaction may be determined based on transaction information gleaned by the first application packet. The transaction information may include identification of a protocol request made by the first application. The transaction information may further include transaction information for a plurality of protocol requests made by the first application. In some embodiments, the transaction information for the plurality of protocol requests may be merged into a single transaction record.

Then, at step 330, a session state may be maintained for the first application in a first application stack. In some embodiments, method 300 may proceed to step 340, where the merged transaction record may be transmitted to an analytics platform. At the analytics platform, the exported transaction record may be buffered in a buffer comprising a plurality of exported transaction records. Predefined queries may then be run on the buffered transaction records at periodic time intervals.

Referring to FIG. 4, another example of an operating environment for embodiments of the present disclosure is shown. Data packets may be travelling across network 440. Such data packets may include application transaction information. Embodiments of the present disclosure may operate in either an active mode or a passive mode. In passive mode, packets may be intercepted at network interceptor 430. The packets may be replicated at network interceptor 430 and then packet copies may be supplied to application transaction engine 410 for further processing.

Alternatively, in active mode the flow is redirected by network interceptor 430 to application transaction engine 410 for processing of transaction information by the transaction state manager 420. Once sufficient information has been gleaned from the packets, the flow may be diverted back to network 440 for continued delivery. The active mode provides application path real-time control, while passive mode provides real-time monitoring capabilities.

In the case where the packets include unencrypted data, the data may not require additional modification by the system. However, if the data is encrypted, the packet must be handled differently.

Network interceptor 430 may intercept an encrypted packet containing application transaction information. As the data is encrypted, it must be decrypted and the appropriate protocol must be identified for processing of the application transaction information. As such, network interceptor 430 may provide the packet to an SSL handler 450. SSL handler 450 operates agnostic to the particular application protocol and associated protocol parser being employed (i.e., HTTP, SMB, SAP, FIX, HL7, etc.). SSL handler 450 may decrypt data using appropriate private keys and certificate ids.

SSL handler 450 may turn the decrypted data to application transaction engine 410 for processing of application-specific transaction information. As part of processing, application transaction engine may be in communication with one or more drive services 460. Drive services 460 may be application or industry specific analytics, compliance and data leakage prevention.

Upon completion of the processing, application transaction engine 410 may provide the decrypted data back to SSL handler 450. SSL handler 450 operates as to re-encrypt the data back to its pre-decryption state. Upon re-encryption, the data is returned to the network 440 flow.

FIG. 5 illustrates a computing device 500, such as a server, host, or other network devices described in the present specification. Computing device 500 may include processing unit 525 and memory 555. Memory 555 may include software configured to execute application modules such as an operating system 510. Computing device 500 may execute, for example, one or more stages included in the methods as described above. Moreover, any one or more of the stages included in the above describe methods may be performed on any element shown in FIG. 5.

Computing device 500 may be implemented using a personal computer, a network computer, a mainframe, a computing appliance, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal. The aforementioned systems and devices are examples and the processor may comprise other systems or devices.

Embodiments of the present disclosure, for example, are described above with reference to block diagrams and/or operational illustrations of methods, systems, and computer program products according to embodiments of this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and are the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

What is claimed is:

1. A method for improving application level intelligence comprising:
establishing an application state machine at a first network device;
constructing a first application data packet;
generating transaction data from the first application data packet relating to a first application at the application state machine; and
transmitting the transaction data related to a first application to a remote entity.

2. The method of claim 1, wherein the transaction information includes identification of a protocol request made by the first application.

3. The method of claim 1, further comprising maintaining the application state machine in an application stack at the first network device.

4. The method of claim 3 wherein the transaction data comprises data related to at least one of: opening a document, closing a document, and saving a document.

5. The method of claim 3, wherein the first application data packet is generated by a protocol parser stored in the application stack.

6. The method of claim 5, further comprising:
operating the first network device in a passive mode; and
extracting application-specific data from data transmitted through the first network device.

7. The method of claim 5, further comprising:
operating the first network device in an active mode;
extracting application-specific data from data terminated at the first network device; and
optimizing a first data flow in-band based on the extracted application-specific data.

8. The method of claim 1, wherein the first application data packet is constructed according to the rules of an object model providing a common interface for identifying and exporting application transactions over a plurality of application domains.

9. The method of claim 8, wherein the first application data packet comprises at least a source IP address, a destination IP address, and information associated with a network flow to one or more contact ports.

10. A method comprising:
intercepting a first data packet on a first network;
providing the first data packet to one of a plurality of application protocol parsers; and
maintaining a session state for the application based in part on information parsed from the first data packet, wherein the session state is maintained at least in part by a first drive service associated with an application associated with the first data packet.

11. The method of claim 10, further comprising:
decrypting the data packet at a first SSL handler;
providing the decrypted data packet to a first application transaction engine.

12. The method of claim 11, further comprising creating a transaction record based on application transaction data gleaned from the first data packet.

13. The method of claim 12, further comprising:
re-encrypting the decrypted data packet at the first SSL handler; and
transmitting the re-encrypted data packet from the first SSL handler to the first network.

14. The method of claim 13, further comprising:
creating a merged transaction record containing a plurality of transaction records; and
exporting the merged transaction record to an analytics platform.

15. The method of claim 14, further comprising:
buffering the exported transaction record in a buffer comprising a plurality of exported transaction records; and
running predefined queries on the buffered transaction records at periodic time intervals.

16. A network device comprising:
one or more network probes configured to learn application data information over a network;
an application transaction aware interface configured to maintain an application state management module for processing learned application data and providing flow management based on the learned application data; and
an analytics engine configured for real-time processing of application events tracked by the application transaction aware interface.

17. The network device of claim 16, wherein the network device is a WAAS device.

18. The network device of claim 17, further comprising a network analytics platform comprising a data buffer used to store application transaction data.

19. The network device of claim 17, further comprising an application driver in communication with the application transaction aware interface.

20. The network device of claim 18, wherein the analytics engine is part of the network analytics platform.
